(19) United States
(12) Patent Application Publication
(10) Pub. No.: US 2004/0095622 A1
(43) Pub. Date: May 20, 2004

(54) Scanner with an adjustable opening for receiving light

(76) Inventor: Ann-Lun Lee, Kaohsiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/421,194

(22) Filed: Apr. 23, 2003

(30) Foreign Application Priority Data
Nov. 14, 2002 (TW) 091133324

(51) Int. Cl. G02B 26/08

(52) U.S. Cl. 359/196; 359/896; 358/474; 358/475

(57) ABSTRACT

A scanner with an adjustable opening for receiving light at least includes a chassis with two grooves and an adjustable grating board. The grooves are positioned at two ends of a first surface on the chassis. A long, narrow opening is built into the first surface so that the light reflected by the document can enter the chassis. The grating board positioned on the built-in opening includes a grating opening and at least two engaging bars. The grooves are positioned and shaped according to shape of the engaging bars so that the grooves can engage with the engaging bars. The grating board can be moved horizontally as the engaging bars slide along the grooves. The grating board is fixed in a precise position and calibrated to reduce unwanted light from entering the chassis.

This application claims the benefit of Taiwan application Serial No. 91133324, filed Nov. 14, 2002.

### BACKGROUND OF THE INVENTION

1. Field of the Invention

The invention relates in general to a scanner, and more particularly to a scanner with an adjustable opening for receiving light.

2. Description of the Related Art

Scanners are devices for capturing images; they convert images that can be initially distinguished only by the human brain, such as photographs and documents, into digital data that can be read by computers. These digital images can be conveniently modified or processed, for example, coupled with a text, or a business document in a brief to improve its colorfulness, or edited and synthesized by various image-processing software to improve their quality or even produce new images. Scanners have become indispensable periphery for PC users and companies due to the advantages mentioned above.

A typical flatbed reflective scanner includes a chassis for receiving image signals, in addition to a cover and a glass flatbed upon which a document is placed to be scanned. FIG. 1 shows a solid view of a conventional flatbed scanner. A light source 110 is positioned on a chassis 100, and a built-in opening 120 is positioned next to and parallel with the light source 110. There are a number of mirrors, a lens, and a photoelectric sensing device (not shown in FIG. 1) in the chassis 100.

FIG. 2 is a cross-sectional view of a conventional flatbed scanner illustrating the scanning process. During the scanning process, light beams emitted from the light source 110, such as light beams 210a and 210b, are reflected by the document 230 being scanned on the glass flatbed 220 to enter the chassis 100 via the built-in opening 120. These light beams 210a and 210b in the chassis 100 are further reflected by mirrors (such as the mirror 240) to the lens (not shown in FIG. 2), and then received by the photoelectric sensing device (not shown in FIG. 2). The photoelectric sensing device converts the light signals into electric signals for digital image output.

As a result of errors during scanner fabrication, the width of the built-in opening 120 is generally designed larger than necessary in order that the scanning light 210a, 210b can enter the photoelectric sensing device as reflected from the document 230. However, as shown in FIG. 2, an opening 120 built too wide will cause excess light to reflect from the part of the document 230 beyond the scan lines 250 (such as the light beam 210b) and enter the photoelectric sensing device 100, thereby generating image distortion and reducing the image scan quality.

### SUMMARY OF THE INVENTION

It is therefore an objective of the invention to provide a scanner with an adjustable opening for receiving light. A grating board, the position of which can be adjusted horizontally, is added to the built-in opening of the chassis. The grating opening of the grating board covers the built-in opening to form a new opening for receiving light. By means of the new opening for receiving light, light reflected from the part of the document beyond the scan lines will be reflected or absorbed by the precisely calibrated grating board. Therefore, image distortion can be reduced, and thus the quality of scanned images can be improved.

The invention achieves the above-identified objectives by providing a scanner with an adjustable opening for receiving light. The scanner includes at least a chassis with two grooves and an adjustable grating board on the built-in opening. The two grooves are respectively positioned at two ends of a first surface of the chassis. The first surface further includes a long, narrow built-in opening where the light reflected from the document will enter the chassis. The grating board includes a grating opening and at least two engaging bars. The grooves and the engaging bars are positioned and shaped so that the grooves can engage with the engaging bar, and the grating board can be moved horizontally.

Other objectives, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a solid view of a conventional flatbed scanner chassis;

FIG. 2 (Prior Art) is a cross-sectional view illustrating the scanning process in a conventional flatbed scanner;

FIG. 3 is an exploded view of a chassis in a scanner according to a preferred embodiment of the invention; and

FIG. 4 is a cross-sectional view illustrating the scanning process of a calibrated scanner according to a preferred embodiment of the invention.

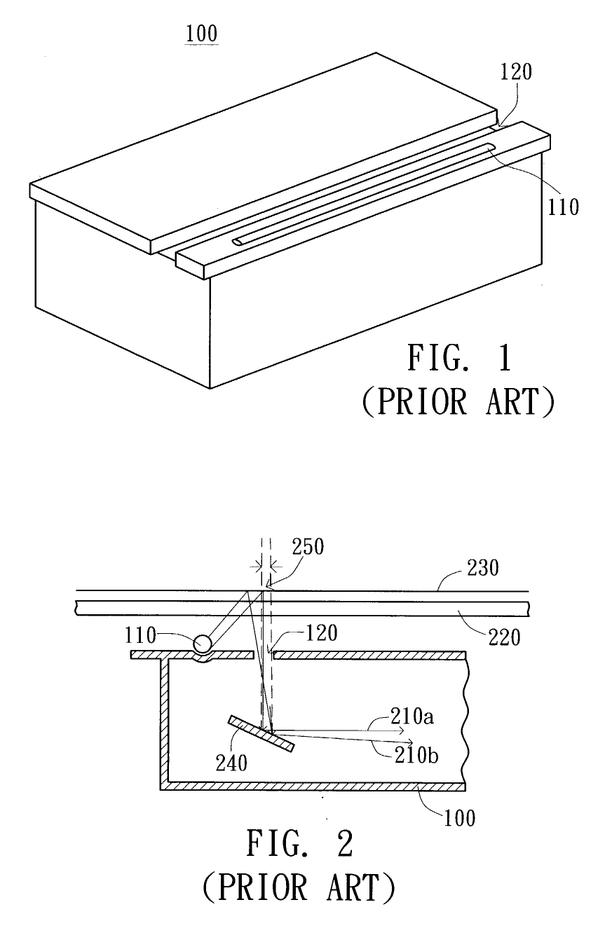

### DETAILED DESCRIPTION OF THE INVENTION

The scanner according to the invention forms a new opening for receiving light by covering the built-in opening with an adjustable grating board that has a grating opening so that light reflected from the part of the document beyond scan lines cannot enter the chassis.

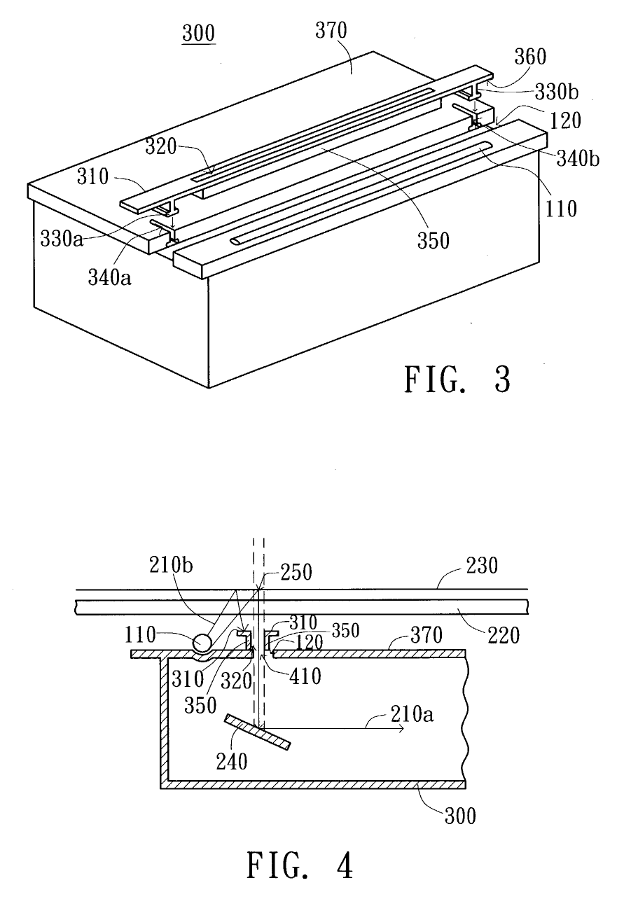

FIG. 3 shows an exploded view of a scanner chassis according to a preferred embodiment of the invention. A grating board 310 is positioned on the built-in opening 120 and includes a grating opening 320, and at least two engaging bars 330a and 330b. The grating opening 320 is parallel with and is at least as long as the built-in opening 120. The two engaging bars 330a and 330b are respectively mounted on two ends of the second surface 360 of the grating board 310. At least two grooves 340a and 340b are respectively formed at two ends of the first surface 370 of the chassis 300 to correspond with the engaging bars 330a and 330b. The grooves 340a and 340b and the engaging bars 330a and 330b are positioned and shaped so that the engaging bars 330a and 330b can engage with the respective grooves 340a and 340b (for example, the cross sections of grooves 340a and 340b are shaped in an inverted T, and engaging bars 330a and 330b also have cross sections shaped in an inverted T.). Therefore, the grating board 310 can be moved horizontally as the engaging bars 330a and 330b slide along the grooves 340a and 340b.

After a scanner is fabricated, an optical path test is performed and the grating board is calibrated to the most precise position and fixed with glue or by screws. FIG. 4 shows a cross-sectional view illustrating the scanning process of a calibrated scanner according to a preferred embodiment of the invention. The grating board 310 with the grating opening 320 covers the built-in opening 120 to form a new opening 410 for receiving light. The new opening 410 allows the light emitted from the light source 110 and reflected by the portion of the document within the scan lines (such as the light beam 210a) to completely enter the chassis 300, while the light reflected by the part of the document beyond the scan lines (such as the light beam 210b) is blocked or absorbed by the block plastic grating board 310.

In order for the light entering the grating opening to be completely received by the chassis, a blocking board 350 is added to the second surface 360 of the grating board 310 and surrounds the grating opening 320. The blocking board 350 and the grating board 310 are made of the same material and molded as a unit. In addition to a reflective scanner, the design of the invention can be applied to a transparency scanner to generate the same effect as mentioned above.

The scanner having an adjustable opening for receiving light disclosed in the invention utilizes a calibrated grating board to reduce the chassis opening and thus reduce the amount of excess light entering the chassis. Light reflected from the portion of the document within scan lines can enter the chassis precisely, while light reflected from the part of the document beyond scan lines is blocked or absorbed, thereby reducing the image distortion and improving the quality of scan images.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanner, with a light source, the light source emitting a light for scanning a document, the scanner comprising at least:
a chassis, movable and positioned in the scanner, the chassis comprising a first surface and at least two grooves at two ends of the first surface, wherein the first surface further comprises a long, narrow built-in opening for the light reflected from the document to enter the chassis;
a grating board, positioned on the built-in opening, the grating board comprising:
a long, narrow opening, having a width smaller than that of the built-in opening, wherein the grating opening is parallel to the built-in opening; and
at least two engaging bars, positioned respectively at two ends of a second surface of the grating board, wherein the first surface of the chassis and the second surface of the grating board are face to face, and the grooves are shaped and positioned to correspond with the engaging bars so that the grooves can engage the engaging bars;
wherein the grating board opening can be moved along the direction of the groove as the engaging bars slide along the grooves, and the grating opening, which has a calibrated position along the built-in opening, can efficiently prevent unwanted light from entering the chassis.

2. The scanner according to claim 1, wherein the scanner is a reflective scanner.

3. The scanner according to claim 1, wherein the scanner is a transparency scanner.

4. The scanner according to claim 1, wherein the length of the grating opening is not shorter than that of the built-in opening.

5. The scanner according to claim 1, wherein the grating board is made of a block plastic material.

6. The scanner according to claim 1, wherein the grating board further comprises a blocking board, positioned vertically on the second surface and surrounding the grating opening to confine the light entering the grated opening.

7. The scanner according to claim 6, wherein the blocking board is made of a block plastic material.

8. The scanner according to claim 7, wherein the blocking board and the grating board are molded as a unit.

9. The scanner according to claim 1, wherein the engaging bars are shaped in an inverted T, and the grooves are also shaped in an inverted T to articulate with the engaging bars.

10. The scanner according to claim 1, wherein the grating board is fixed on the chassis with glue after it is calibrated.

11. The scanner according to claim 1, wherein the grating board is fixed on the chassis by a screw after it is calibrated.
